(19) United States
(12) Patent Application Publication
(10) Pub. No.: US 2013/0124268 A1
(43) Pub. Date: May 16, 2013

(54) SYSTEMS AND METHODS FOR IDENTIFYING EXPERTS

(71) Applicants: James Hatton, Odessa, FL (US); Jenny Blackburn, San Francisco, CA (US); Jeanette Zalder, Alameda, CA (US); Kavitha Musthyala, Dublin, CA (US); Judy Feng, San Bruno, CA (US)

(72) Inventors: James Hatton, Odessa, FL (US); Jenny Blackburn, San Francisco, CA (US); Jeanette Zalder, Alameda, CA (US); Kavitha Musthyala, Dublin, CA (US); Judy Feng, San Bruno, CA (US)

(21) Appl. No.: 13/673,728

(22) Filed: Nov. 9, 2012

Related U.S. Application Data
(60) Provisional application No. 61/558,017, filed on Nov. 10, 2011.

(51) Int. Cl. G06Q 10/06

(52) U.S. Cl. 705/7.38

(57) ABSTRACT

Disclosed herein are systems and computer readable storages for identifying experts with particular talents among participants in an online social network. Identification of experts with particular talents identified by talent-labels can take into account multiple factors. One factor that can be applied is self-nomination. Individuals who offer to help others can be expected to offer assistance in areas where they have strong talents. Another factor that can be applied is endorsements by others. A co-worker making an endorsement can be encouraged or required to supply narrative that describes experience with the nominee's actual work. Another factor that can be applied is data mining by semantic analysis or other techniques, taking advantage of access to fielded databases that describe a nominee's work activities. One or more proficiency scores can be derived from these and other factors and used when responding to queries or generally when compiling expertise inventories or talent banks

### RELATED APPLICATION

This application claims the benefit of U.S. Provisional Patent Application No. 61/558,017, entitled, “Systems and Methods for Identifying Experts,” filed on 10 Nov. 2011. The provisional application is hereby incorporated by reference for all purposes.

### BACKGROUND

1. Field

Disclosed herein are systems and methods for identifying experts with particular talents among participants in an online social network.

2. Related Art

The last few years have seen significant growth in the number of business users of online social networking services like Chatter®, which is offered by salesforce.com, inc. These users may be within the same company or other organization (intra-company) or may span organizations. While business use of social networks increases the opportunity to interact and collaborate with other users, the number, geographic distribution or organizational structure of people participating in the social network may make it difficult to identify an “expert” with particular talents who is available to answer questions. User applied talent-labels or other keyword identifiers can flag a relevant subject matter, but this does not automatically identify users by their degree of talent in a specific area.

It is desirable to provide a tool for identifying experts with particular talents that are accessible within a user's social network.

### SUMMARY

Disclosed herein are systems and methods for identifying experts with particular talents among participants in an online social network. Identification of experts can take into account multiple factors. One factor that can be applied is self-nomination. Individuals who offer to help others can be expected to offer assistance in areas where they have strong talents. However, self-nomination may be perceived as biased. Another factor that can be applied is endorsements by others. A co-worker making an endorsement can be encouraged to supply narrative that describes experience with the nominee's actual work. Endorsements accompanied by narrative can be given greater weight than simple endorsements without a narrative. Another factor that can be applied is data mining by semantic analysis or other techniques, taking advantage of access to work activity databases that describe a nominee's work activities. These databases may be fielded databases. One or more proficiency scores can be derived from these and other factors. Proficiency scores can be based on individual factors or combinations of factors. The proficiency scores can be used when responding to queries or generally when compiling expertise inventories or talent banks.

The technology disclosed provides more useful identification of subject matter experts. It also provides a quantification of their expertise across particular talents. Instead of rating an expert for their general competence, participants in a social network can identify experts with the particular expertise that they are seeking.

Other aspects and advantages of the present invention can be seen on review of the drawings, the detailed description and the claims, which follow.

### BRIEF DESCRIPTION OF THE DRAWINGS

FIG. 1 illustrates an example environment in which the technology disclosed can be practiced.

FIG. 2 is a block diagram of an example implementation of the technology disclosed.

FIG. 3 is an example flow chart.

FIG. 4 is an example of data structures.

FIG. 5 is an example screenshot illustrating a user's profile page with a list of “Expertise,” including “Apex Code,” “API Verbs,” “database.com,” etc.

FIG. 6 illustrates a “proficiency score” that includes ratings from three categories.

FIG. 7 is an example screenshot illustrating the number of available experts for specific categories, such as VisualForce, Opportunity Splitting, Heroku, and the like.

FIG. 8 illustrates use of a search box, as well as relevant results.

FIG. 9 is an example screenshot of one of the three database.com experts showing recent endorsements for the user.

FIG. 10 is an example screenshot of a dialogue box.

FIG. 11 is an example screenshot of a user posing a question to an expert.

FIG. 12 is an example screenshot of an expert's view of a question posed.

FIG. 13 is an example computer system.

### DETAILED DESCRIPTION

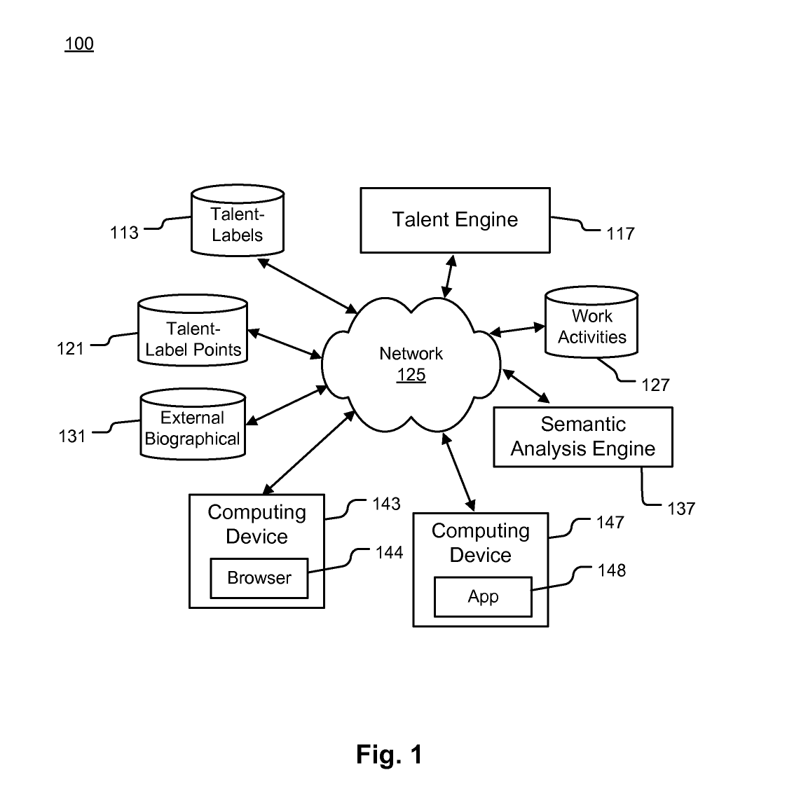

Implementations of the technology described are provided with reference to the FIGS. 1-13.

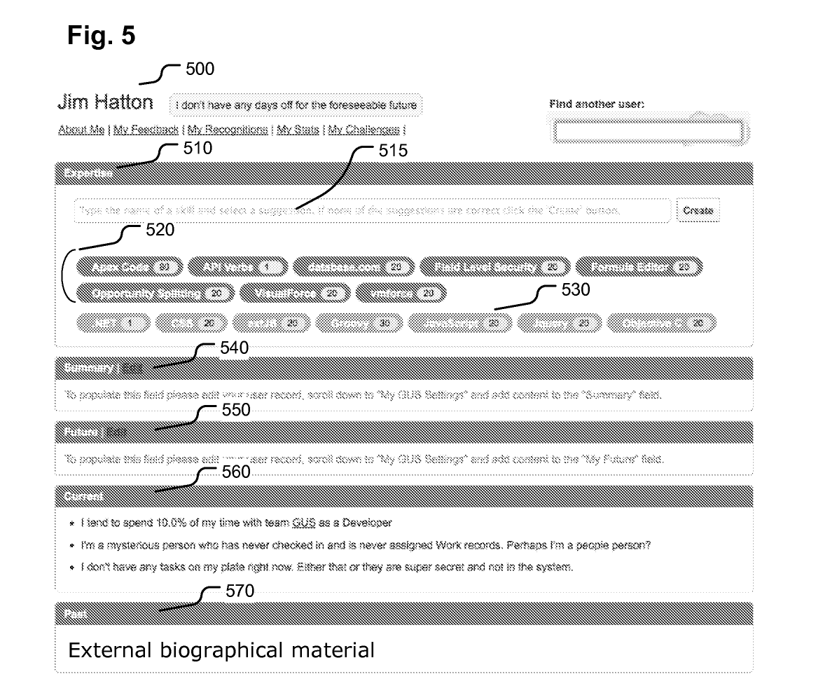

The technology disclosed assists with scoring particular talents of participants in an online social network and with identification of experts with those talents. The system and method described categorized talents. The talents can apply to a category of intra-company specific tasks, such as “Apex Code,” “API Verbs,” “database.com,” etc. The talents can apply to a relatively more general category of industry-wide skills, such as “JavaScript”. Additional examples of first and second categories of talents appear in FIG. 5. Talent-labels, classifications or keywords for specific tasks and general skills can be selected from standard talent-labels or can be created as custom talent-labels when a person is nominated as an expert having a particular talent.

The talent engine scores expertise per talent-label, rather than per individual. This granular level of scoring helps identify experts with particular talents, as opposed to generally strong performers or well-liked helpers. The scoring incorporates multiple factors that assist in talent evaluation.

A user interacting with the talent engine can search for relevant talent-labels in a variety of ways. Users viewing query results can drill down to see more detailed profiles of individual experts.

An individual profile can list talent-labels and talent-label points for a nominee. In some implementations, the talent-labels could be organized by category, level of expertise, points, alphabetically or in any useful order. Individual profiles can incorporate external biographical data, in addition to talent evaluation data.

FIG. 1 illustrates a block diagram of an example environment 100 in which a talent engine 117 can be used. The environment 100 includes computing devices 143, 147, the talent engine 117, a semantic analysis engine 137 and various databases 113, 121, 127, 131. The environment also includes a communication network 125 that allows for communication among various components of the environment 100.

During operation, users interact with the talent engine 117 through computing devices 143, 147. The computing devices 143, 147 and the talent engine 117 each include memory for storage of data and software applications, a processor for accessing data and executing application, and components that facilitate communication over the communication network 125. The computing devices 143, 147 execute applications, such as Web browsers (e.g., Web browser 144 executing on computing device 143, and app 148 executing on computing device 147) that allow users to make nominations, to make endorsements and to formulate queries and submit them to the talent engine 117. The talent engine 117 receives talent information and talent queries that may have originated with the computing devices 143, 147 and updates or queries various databases 113, 121, 131. The talent engine 117 processes new nominations and connects nominees with talent-labels 113. The talent engine 117 further accumulates talent-label points 121 specific to talent-labels for the nominees. This includes interacting with users and can include processing data from other subsystems such as the semantic analysis engine 137. Talent engine 117 can be part of an overall system that has access to at least one fielded database that describes work activities 127 of the nominees. For example, in response to a query to identify relevant talent-labels received from computing device 143, the talent engine 117 can access the talent-labels database 113 transmit a talent-labels selection page to be displayed in browser 144 executing on the computing device 143. As another example, in response to a query that specifies selected talent-labels received from computing device 143, the talent engine 117 can access the talent-label points database 121 and transmit a list of experts with their relevant talent-labels and corresponding talent-label points.

In one implementation, the network 125 includes the Internet. The network 125 can also utilize dedicated or private communication links that are not necessarily part of the Internet. In one implementation, the network 125 uses standard communication technologies, protocols and/or inter-process communication technologies.

The client computing device 143, 147 executes an application such as a Web browser 144 or an app 148, which interacts with the talent engine 117. The client computing device 143, 147 may be for example a desktop computer, a laptop, a tablet computer, a mobile phone, or any other type of computing device.

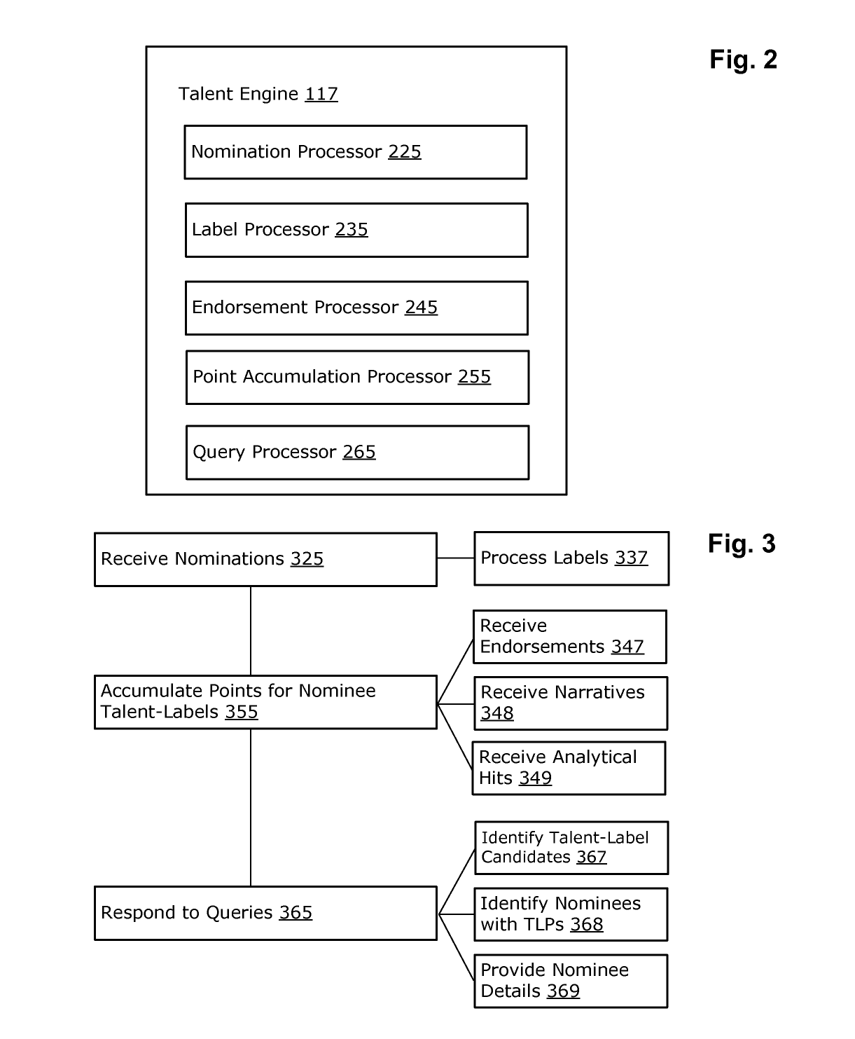

The talent engine 117 can be implemented in hardware, firmware, or software running on hardware. The talent engine 117 is described in more detail below with respect to FIGS. 2-4.

The databases 113, 121, 127, 131 can be collectively stored on multiple computers or storage devices. A single, multitenant database that handles multiple object types can store some or all of the internal databases for talent-labels 113, talent-label points 121 and work activities 127.

The talent engine 117 provides graphic user interfaces for display on the client device 143, 147. The graphic user interfaces facilitate submission of nominations, endorsements and queries by the user. Examples of some of these interfaces appear in FIGS. 5-10.

FIG. 2 is a block diagram illustrating example processors within the talent engine 117. In FIG. 2, the talent engine 117 includes the nomination processor 225, label processor, 235, and endorsement processor 245, point accumulation processor 255 and a query processor 265. Some implementations may have different and/or additional modules than those shown in FIG. 2. Moreover, the functionalities can be distributed among the modules in a different manner than described herein, with processing aggregated into fewer processors.

The nomination processor 225 accepts nominations and self nominations. The nominees are proposed as experts, typically with a plurality of talent-labels. While it is possible for nominee to have a single talent-label, it is expected that experts will have multiple talent-labels, in a well-organized labeling system. It is expected that experts will have talent-labels in multiple categories, including a first, relatively specific category and a second category that is relatively broader than the first. For instance, the first category may be talents related to company tasks or systems and the second category may be talents applicable across an industry. Additional categories could be provided for grouping talents. Preferably, talents belong to one category or another. In some implementations, talents could belong to more than one category. Nominees are members of a social network or other organization, so the nomination processor can verify the identity of nominees. Nominations can be self nominations or endorsements that apply a talent-label to a nominee that had not previously been applied. The nomination processor 225 can rely on the label processor 235 to process labels the company nominations.

The label processor 235 interacts with the talent-labels database 113. It generates user interfaces that can be provided to user for identification of relevant talent-labels to apply to a nominee. A user can use an interface to search for relevant labels in any of the ways described above. For example, the interface may allow the user to interact with a checkbox list or to enter labels and suggest auto completions, for instance in a drop down menu. The label processor 235 also accepts new labels during nomination and updates the talent-label database 113 accordingly. The label processor 235 also can be used by the endorsement processor 245 to identify relevant talent-labels or to create custom talent-labels.

The endorsement processor 245 interacts with the talent-label points database 121. It generates one or more user interfaces that can be provided to a user to endorse a nominee for specific talent-labels. A user can use an interface to search for relevant labels or to create new labels. The endorsement processor 245 can encourage a co-worker to write a narrative or story that describes the co-worker's experience with the nominee's skills corresponding to a specific talent-label. An endorsement can be accepted without a narrative or with the related narrative. A related narrative can be analyzed semantically or otherwise for connection to the talent-label being applied to the nominee. The user could be prompted to give an improved description in the narrative, based on the analysis, or the system could use the analysis without further interaction with the user. An endorsement with narrative can be given greater weight than an endorsement without a narrative. Endorsements are one of the factors considered by the point accumulation processor 255.

The point accumulation processor 255 accumulates talent-label points 121 for particular nominees. The talent-label points 121 can be accumulated across a variety of factors. For instance, self nominations can be awarded points. Co-worker endorsements can be awarded points and more points awarded for the endorsements accompanied by a narrative. A semantic analysis engine 137 or other analysis engine can communicate results of evaluating work activities 127 to the point accumulation processor 255. The point accumulation processor 255 can maintain details of factors that contribute to talent-label points 121. A running total of talent-label points 121 can be maintained, subtotals of talent-label points by factor can be maintained, or the talent-label points can be calculated on-the-fly. The point accumulation processor can calculate one or more proficiency scores based on the talent-label points.

For particular talent-label 113, the talent-label points 121 can be calculated according to the following formula:

TLP=(a*SN)+(b*END1)+(c*END2)+(d*SEM), where
TLP is the talent-label points,
a, b, c and d are weights,
SN is a Boolean for self-nomination,
END1 is a count of co-worker endorsements accompanied by descriptions of the nominee's application of their talent,
END2 (optional) is a count of co-worker endorsements not accompanied by descriptions, and
SEM is a determination of talent application instances returned by semantic analysis of the intra-company fielded databases.

Useful weights can be identified without undue experimentation. In one implementation, a weight of 20 can be applied to self nomination, a weight of 10 can be applied to endorsements with descriptions, a weight of five can be applied to endorsements without descriptions, and a weight of one or two can be applied to instances of talent application identified by a semantic analysis engine 137 or other analytical engine that evaluates work activities 127 of the nominee. In some categories, weights assigned to factors can diminish with elapsed time. Alternatively, increasing weights can be applied as time progresses, effectively depreciating the value of earlier contributions to talent-label points. Results of point accumulation processing 255 can be used by the query processor 265 to respond to certain types of queries.

The query processor 265 interacts with users to identify relevant talent-labels, to identify experts with accumulated talent-label points for selected talent-labels, to provide detailed information about identified experts, and to facilitate communications with experts. The communications with experts can involve a handoff to another engine such as a chatter engine that is separate from the talent engine 117. The operation of the talent engine 117 can be described or reference to the flowchart in FIG. 3.

FIG. 3 is an example flowchart provides different levels of detail for implementation of the processing disclosed. Other implementations may perform the steps in different orders and/or perform different or additional steps than the ones illustrated in FIG. 3. For convenience, FIG. 3 will be described with reference to a system of one or more computers that perform the process. The system can be, for example, the talent engine 117 has described with reference to FIG. 2. At a high-level, the flow includes receiving nominations 325, accumulating points for nominee talent-labels 355 and responding to queries 365.

At step 325, a nomination processor 225 receives nominations. Nominations associate talent-labels with nominees. In subsequent steps, talent-label points will accumulate for the nominee's particular talent-labels. In some implementations, receiving nominations 325 includes processing labels 337. Processing labels can include selecting standard talent-labels, selecting previously entered custom talent-labels, or creating and selecting new custom talent-labels. The talent-labels can be organized by keyword, hierarchy, or both. The talent-labels can further be clustered or associated with one another by a recommendation and/or collaborative filtering engine.

At step 355, the point accumulation processor 255 accumulates points for nominee talent-labels 355. In subsequent steps, talent-label points can be used to respond to queries or to generate talent inventories. In some implementations, accumulating points for nominee talent-labels 355 includes receiving endorsements 347, receiving narratives 348 and receiving analytical hits 349. Data received can be stored in the talent-label points database 121. Receiving endorsements 347 can be proceeded by generating a user interface, leading to receiving results of user interaction with the interface. The user interface can be generated by the talent engine 117 or presentation layer. Receiving endorsements 347 includes assigning talent-labels to nominees or commenting on previously assigned talent-labels. Receiving narratives 348 can accompany receiving endorsements 347. Receiving analytical hits 349 can involve interaction with the semantic analysis engine 137 or other analytical engine. The analytical hits received can be coming via a link to a work activities database 127. The analytical hits received can have equal weights or can be assigned varying weights by the engine from which they are received.

At step 365, the query processor 265 response to queries 365. Responses can be generated for a variety of queries. For example, responses can be generated for queries seeking to identify talent-label candidates 367. Candidate talent-labels can be identified responsive to keyword queries, expansion of the hierarchy, or partial entry of the keyword. Keyword searches can be supported, with or without thesaurus support. A recommendation engine using collaborative filtering or other techniques can recommend talent-labels responsive either to a keyword search or to selection of one or more talent-labels. A taxonomy can be provided to facilitate selection of labels and branches of multiple labels. Selected talent-labels can be the basis for searching for experts.

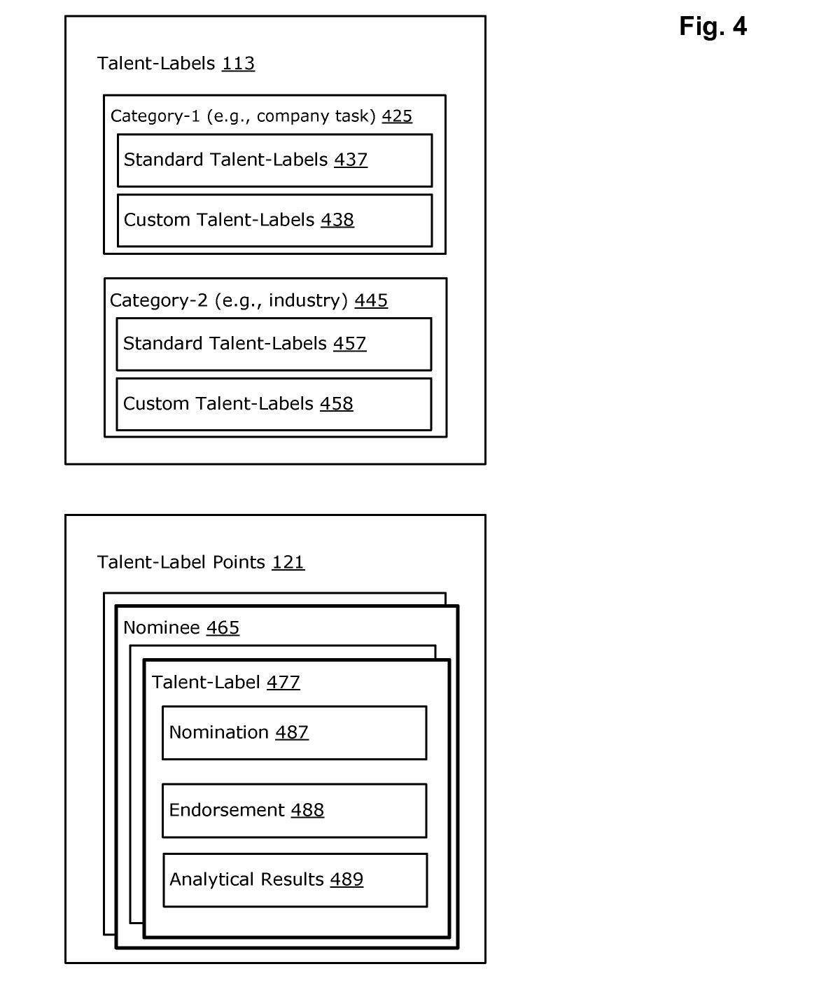

Responses to queries by talent-label can identify nominees with accumulated talent-label points applied to selected talent-labels 368. Either a query processor 265 or presentation layer can present a user with an interface that identifies nominees and their relevant talent-label points. The query processor 265 can receive request for detailed information regarding particular nominees. Responding to queries 365 can include providing nominee details about 369. This can include a list of a user's talent-labels and their talent-label points. It can include the text of endorsements relevant for selected talent-labels. It can include external biographical information 131 from another source, such as LinkedIn or Facebook. The overall process flow described can be supported by the data structures depicted in FIG. 4.

FIG. 4 is an example of data structures that can be used with the talent-label database 113 and the talent-label points database 121. The talent-labels database 113 can be organized into two or more categories 425, 445. The categories can be differentiated by specificity. The second category can be relatively more general than the first category. For example, the first category can be company task 425 and the second category industry recognized skills 445. Categories include both standard talent-labels 437, 457 they can be configured when the database is established and custom talent-labels 438, 458 that are added in response to user interactions. Periodically, custom talent-labels can be incorporated in a standard talent-labels list or hierarchy. Tools can be provided to merge custom talent-labels with other custom talent-labels or with standard talent-labels, so as to avoid proliferation of closely related labels. Not shown, talent-labels can be accompanied by descriptions that define their intended use.

The talent-label points database 121 can be organized by nominee 465. Nominees have multiple talent-labels 477. Talent-label points are accumulated for a talent-label 477 based on a variety of factors. For instance, talent-label points 121 can be accumulated for nominations 487, endorsements 488 or analytical results 489. In the talent-label points database 121, denomination or reference to nomination 487 can be stored. For a particular talent-label 477, nomination associated points 487 can be accumulated on a weighted or unweighted basis. Endorsements or references to endorsements 488 can include identity of the endorsing social network member and accompanying narrative. Analytical results or references to analytical results 489 can include results returned by the semantic analysis engine 137 or other analytical engine. Endorsement and analytical associated points can be accumulated on a weighted or unweighted basis. The talent-label database 113 and talent-label points database 121 report the same overall database structure. They can be organized as separate tables or as different object types within the same table. With the underlying structure in mind, we turn to example interfaces.

FIG. 5 is an example screenshot illustrating a user's profile page 500 with a description of Expertise 510, including two categories 520, 530. Labels in the first category 520 include Apex code with a talent-label points score of 80, API Verbs with a score of 1, database.com, Field Level Security, Formula Editor, Opportunity Splitting, VisualForce, and vmforce. In this example, the first category can be skills that are relatively specific to salesforce.com. In this example, Apex Code is a language supported by salesforce products and VisualForce is one of the salesforce products. Labels in the second category 530 include .NET, CSS, extJS, Groovy, JavaScript, Jquery and Objective-C. In this example, the second category is relatively more general than the first category. The second category includes industry-wide technologies that are not specific to salesforce.com products. In the interface, talent-labels in the two categories 520, 530 are visually distinguished. The categories can be distinguished by position and/or appearance. Within a category, the talent-labels can be organized alphabetically or by proficiency score. The interface can provide a filter that allows a user to select a minimum proficiency score either in this detailed view or in a list of experts.

In order to standardize available areas of expertise, a user having appropriate privileges can select a set syntax or define a talent-label for a skill. In some implementations, every user can create talent-labels. When a user edits his or her profile and types in a skill, the standardized label may appear as an available choice. Alternatively or additionally, a user can list skills without using a standardized list. In this fashion, a user can endorse him- or herself as an expert in specific areas.

While self-endorsement can be an effective way to identify expertise, it may not be perceived as unbiased. In an embodiment, a first user may endorse a second user for a specific area of expertise, i.e., a peer endorsement. The endorsement may be for a skill from a list of standardized areas of expertise, or the endorsement may be for an unlisted skill.

In some implementations, a user may be identified as an expert by his various posts to the online social network, i.e., based on semantic analysis credit. For example, if the user responds to questions on database.com, which is an on-line database service offered by salesforce.com, inc., then the user may be considered an expert on database.com. Similarly, if other users tend to “like” or otherwise indicate approval of the user's posts, these actions may be used to identify the user as an expert. Semantic credit for expertise may be based upon interaction with one or more records, bugs, or other data objects in an enterprise system. Generally, information of this sort can be stored in one or more work activities databases 127 where available to the semantic analysis center 137 or other analytical engine. Work activity databases typically are fielded databases that are more amenable to semantic analysis than free text documents.

Other areas of the user profile 500 can include user summary information 540, user future activities information 550, user current activities information 560 and user past activities information 570. The summary information 540 can be a user provided expertise summary. The future activities information 550 can be a user supplied description or it can be automatically generated from work records. The current activities information 560 can be user supplied or automatically generated from work records. The past activities information 570 can be obtained from an external biographical source, such as LinkedIn or Facebook, or an internal social network-related biographical source. The source can be maintained by social network members or by a human relations or publicity department. The proficiency scores displayed this example interface combine a variety of factors.

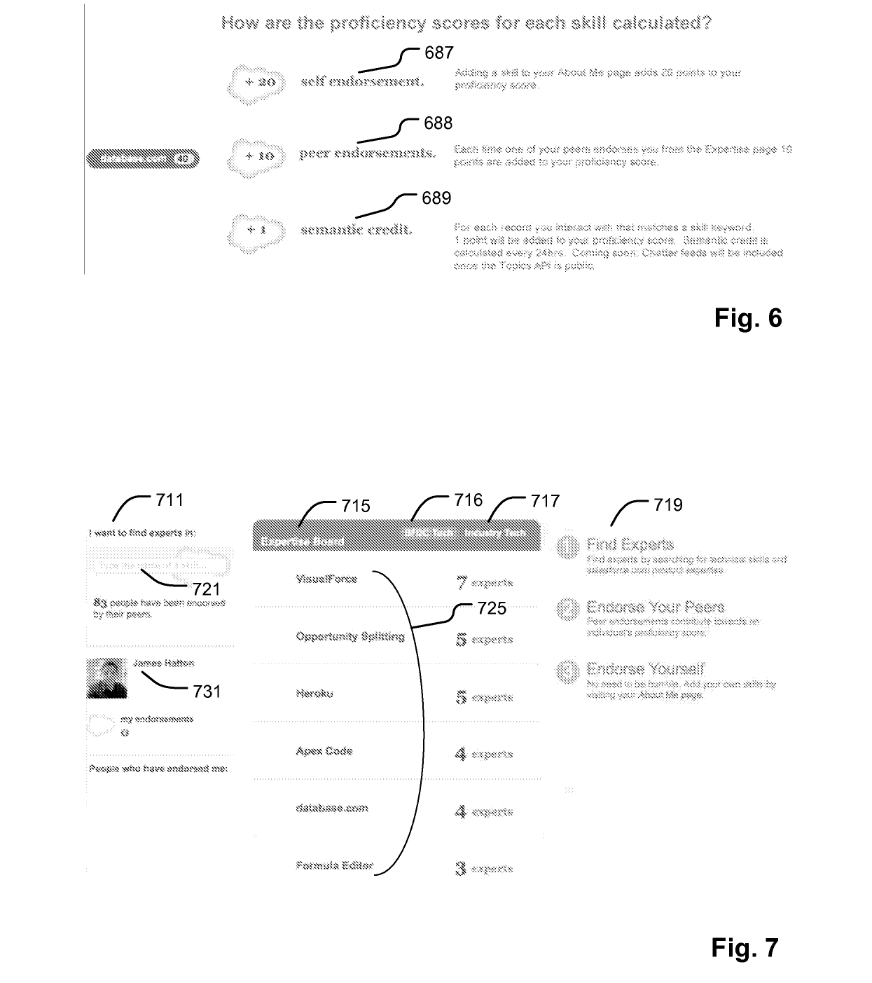

Self-endorsement, peer endorsement, and semantic credit can each be effective ways for rating a user's level of expertise in specific areas. However, it can be more effective to combine two or three of these factors. FIG. 6 illustrates an example “proficiency score” that includes ratings from three factors. In various implementations, a proficiency score may be comprised of a single rating, or two or more ratings combined by application of weighting values.

In the illustration, example weights are given for self endorsement 687, peer endorsements 688 and semantic credit 689. The example weight for self endorsement or self-nomination 687 is 20 points. A nominee only nominates himself once for a particular talent-label. The example weight for peer endorsements 688 is 10 points. In some implementations, the weight assigned to peer endorsements 688 may vary, depending on whether the endorsements are accompanied by a narrative. In other implementations, endorsements could be required to be accompanied by a narrative. Endorsement narratives can be analytically or semantically evaluated to ensure that they make sense for the talent-label that is being endorsed. Display of proficiency scores using these weights is illustrated in FIG. 5, above. Proficiency scores can be used to rank social network users based on expertise that corresponds to talent-labels. Proficiency scores can facilitate discovery or inventorying of experts with particular skills.

FIG. 7 is an example screenshot illustrating an expertise board 715 that gives the number of available experts 715 for specific talent-labels 725. In this example, the talent-labels 725 include VisualForce, Opportunity Splitting, Heroku, and the like. The left-hand column of this interface includes a query area 711 with a search box 721 into which a user types a keyword associated with one or more talent-labels. The left-hand column also identifies the current user 731 and can provide information regarding endorsements by and of the current user. The title part of the expertise board 715 can include filters for selecting talent-labels by category 425, 445. The filter selectors in this example are for salesforce.com technology 716 and industry technology 717. The right-hand column 719 in this example informs the user that the interface can be used to find experts, endorse peers or self-endorse the user.

In some implementations, the parents of these interfaces can be rearranged. The order of columns can be changed. Vertical orientations can be changed to horizontal orientations. Positions of things on the interface pages may be user configurable.

In some implementations, a user can search for an expert by typing in the desired subject matter in the search box 721, and/or using a “leaderboard” as is shown in FIG. 7.

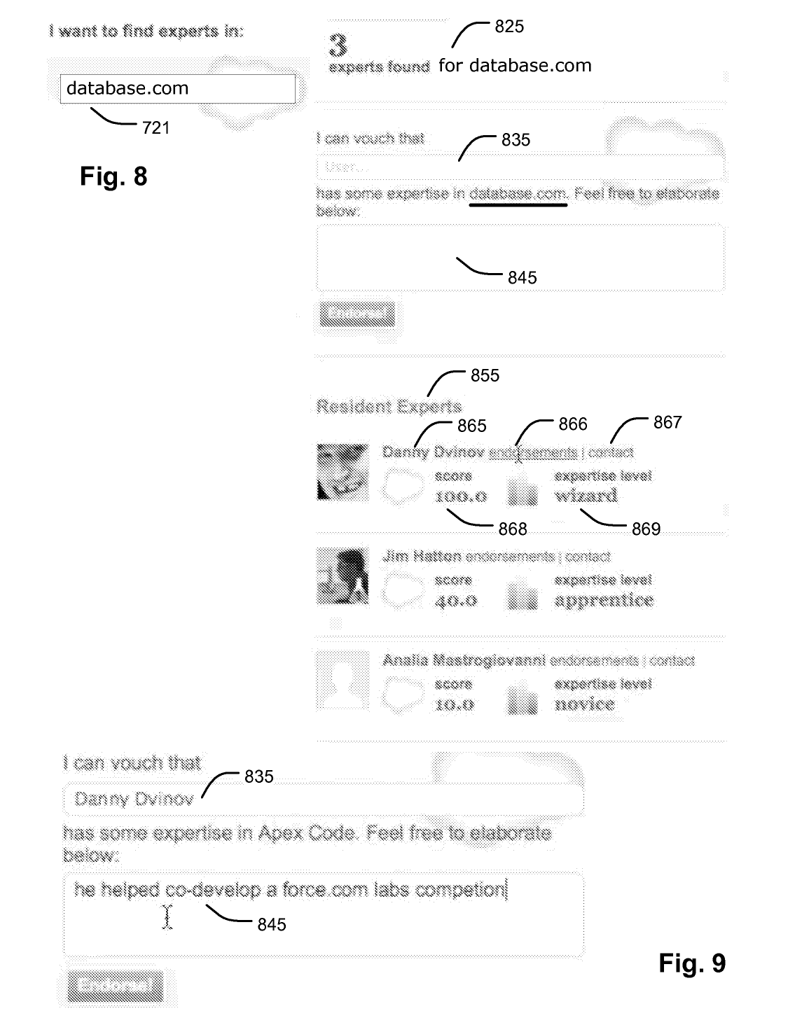

FIG. 8 illustrates use of the example search box 721, as well as relevant results 855. As shown, the search term, “database.com” 721 is used to identify experts 855 in database.com technology. Three resident experts are located. For a particular expert 865, the expert's name is given and links are provided for reading endorsements of the expert 866 and for contacting the expert 867. The combined proficiency score for the database.com is given 868 for that talent-label 825. The expertise level of this particular expert 869 is rated “wizard.” The addition of a level can add a “gamification” feel to the interface that will motivate some users to adopt the expertise feature of a social network. In an embodiment, a user can directly contact the expert or post to the expert's profile page.

FIG. 9 illustrates an example of the vouching fields 835, 845 shown in FIG. 8. In this example, a user types the expert's name 835 and adds the text, “he helped develop a force.com labs competition” 845. The user can be assisted identifying the expert from their vouching by a partial completion feature. This feature can be keyed to the experts found, to the names of participants in the social network, or both.

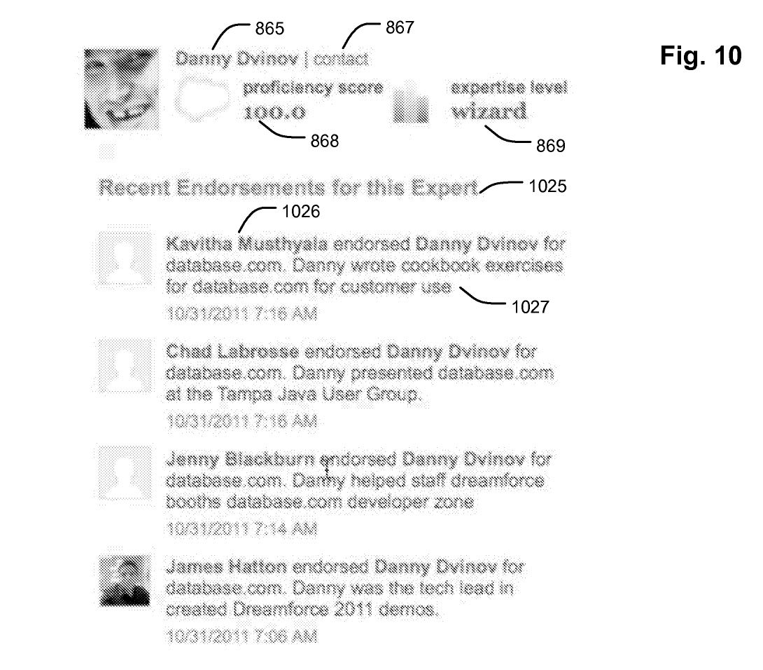

FIG. 10 is an example of details for a particular expert 865. The proficiency score and expertise level 868, 869 are repeated. The contact button 867 is repeated. Recent endorsements of the expert 1025 are displayed. A sample endorsement includes the endorsing user's name 1026 and, optionally, a brief narrative accompanying the endorsement 1027. In the other implementations, endorsements are required to be accompanied by narrative.

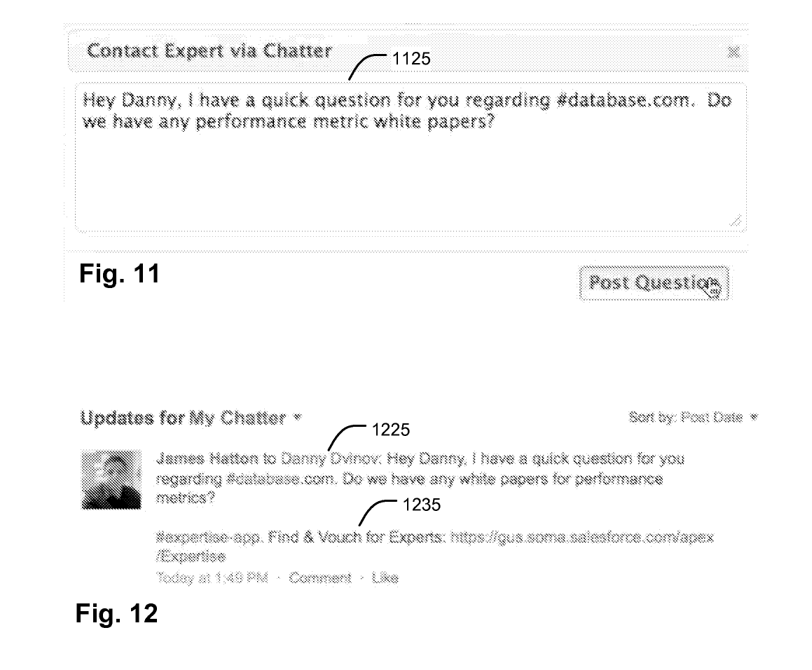

FIG. 11 is an example screenshot of a dialogue box that may appear when a user selects “contact” from the screenshot of FIG. 8 or 10. The user can pose a question 1125 to the expert, which may then be posted to the expert's profile page or social network newsfeed, as shown in FIG. 12. The expert sees on their interface the name of the person asking the question and their question 1225. A link also is provided 1235 for accessing the expertise application.

By posting a question to an expert's newsfeed, the question can be made public such that other users viewing the expert's newsfeed may also respond. Alternatively or additionally, the expert may respond and may post the answer as a comment, thereby allowing other users to view the answer.

Following a satisfactory answer, the user seeking expert advice can then endorse the expert, thereby contributing to the expert's peer endorsement rating, and subsequently, proficiency score.

In this fashion, locating and promoting users as experts can be made “social” in an online social network context.

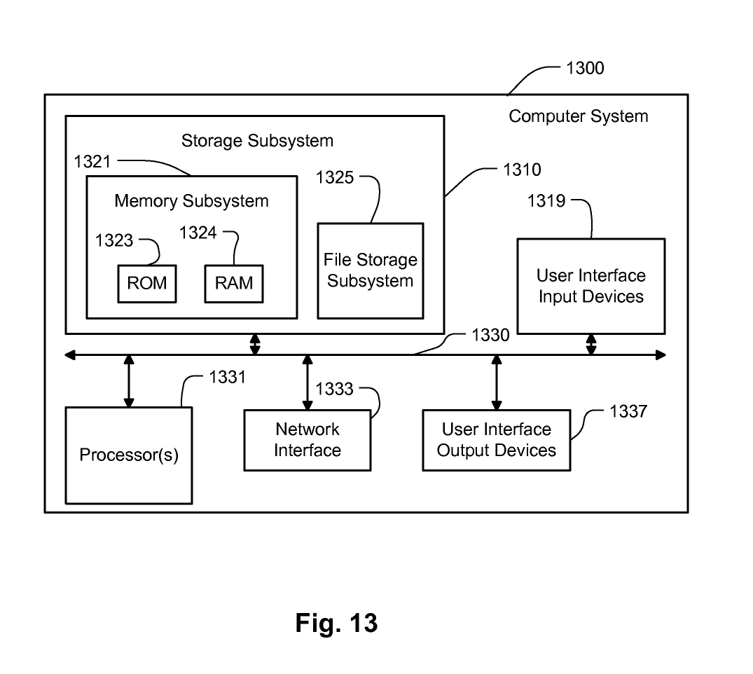

FIG. 13 is a block diagram of an example computer system. Computer systems 1300 typically include at least one processor 1331 that communicates with a number of peripheral devices via bus subsystem 1330. These peripheral devices may include a storage subsystem 1325, comprising for example memory devices and a file storage subsystem, user interface input devices 1319, user interface output devices 1337, and a network interface subsystem 1333. The input and output devices allow user interaction with computer system 1300. Network interface subsystem 1333 provides an interface to outside networks, including an interface to communication network 125, and is coupled via communication network 125 to corresponding interface devices in other computer systems.

User interface input devices 1319 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into computer system 1300 or onto communication network 125.

User interface output devices 1337 may include a display subsystem, a printer, a fax machine, or non-visual displays such as audio output devices. The display subsystem may include a cathode ray tube (CRT), a flat-panel device such as a liquid crystal display (LCD) or light emitting diode display (LED), which may be touch sensitive, a projection device, or some other mechanism for creating a visible image. The display subsystem may also provide non-visual display such as via audio output devices. In general, use of the term “output device” is intended to include all possible types of devices and ways to output information from computer system 1300 to the user or to another machine or computer system.

Storage subsystem 1325 stores programming and data constructs that provide the functionality of some or all of the modules described herein, including the logic to identify related queries that represent different information requests according to the processes described herein. These software modules are generally executed by processor 1331 alone or in combination with other processors.

Memory 1321 used in the storage subsystem can include a number of memories including a main random access memory (RAM) 1324 for storage of instructions and data during program execution and a read only memory (ROM) 1323 in which fixed instructions are stored. A file storage subsystem 1325 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 1325 in the storage subsystem 1324, or in other machines accessible by the processor.

Bus subsystem 1330 provides a mechanism for letting the various components and subsystems of computer system 1300 communicate with each other as intended. Although bus subsystem 1330 is shown schematically as a single bus, alternative embodiments of the bus subsystem may use multiple busses.

Computer system 1300 can be of varying types including a workstation, server, computing cluster, blade server, server farm, or any other data processing system or computing device. Due to the ever-changing nature of computers and networks, the description of computer system 1300 depicted in FIG. 13 is intended only as a specific example for purposes of illustrating the preferred embodiments. Many other configurations of computer system 1300 are possible having more or fewer components than the computer system depicted in FIG. 13.

### Particular Implementations

In one implementation the method is described that includes identifying particular technical talent within an organization. This method includes receiving talent nominations that include two or more talent-labels that identify a nominee's technical talents in a first category and a second category, wherein talent-labels in the first category are more specific to the organization to which the nominee belongs than talent-labels in the second category. In some implementations, more than two categories can be used to group talent-labels. The first category can list intra-company task talents and the second category can list industry wide talents. Examples of talents these categories are given above. The method can further include accumulating talent points for the nominees' talent-labels, including assigning talent-label points for at least co-worker endorsements and from semantic analysis of intra-company fielded databases.

This method and other implementations the technology disclosed can each optionally include one or more the following features.

The method can include responding to queries for particular technical talents by identifying one or more relevant talent-labels, one or more nominees for each relevant talent-label, and the identified nominees' talent-label points.

An additional category of talent-labels can be included. For example, talent-labels in the category of personal or recreational skills can be collected.

Talent-labels can be created on demand while collecting a particular talent nomination or endorsement.

A co-worker endorsement can be accompanied by a narrative, either optionally or as a requirement of making an endorsement. The narrative can be qualified semantic analysis of the narrative's content.

Talent-label points can be assigned for self-nomination.

Talent-label points can be calculated according to the formulas given above.

Responding to the queries can include searching the talent-labels by keyword and/or presenting a taxonomy of talent-labels.

Responding to follow-up queries can include providing details on one or more nominees, including the particular nominee's talent-labels, talent-label points and a self-description of the particular nominee. The self-description can be obtained from an external biographical source.

Other implementations may include a non-transitory computer readable storage medium storing instructions executable on a processor to perform any of the methods described. Implementations also may include systems including memory and one or more processors operable to execute instructions, stored in the memory, to perform any of the methods described.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method of identifying particular technical talent within an organization, including:
receiving a talent nomination that includes two or more talent-labels that identify a nominee's technical talents in a first category and a second category, wherein at least some of the talent-labels in the first category are more specific to the organization to which the nominee belongs than the talent-labels in the second category,
accumulating talent-label points for the nominee's talent-labels, including assigning talent-label points for at least co-worker endorsements and from analysis of at least one work activity database that describes work activity of the co-worker, and
responding to queries for particular technical talents by identifying one or more relevant talent-labels, one or more nominees for each relevant talent-label, and the ii identified nominees' talent-label points.

2. The method of claim 1, wherein the first category lists intra-company task talents and the second category lists industry wide talents.

3. The method of claim 1, further including one or more additional categories, in addition to the first category and the second category.

4. The method of claim 1, further including talent-labels in an additional category of personal or recreational skills.

5. The method of claim 1, further including creating at least one of the talent-labels on demand while collecting a particular talent nomination.

6. The method of claim 1, further including enhancing the talent-label points for a co-worker endorsement when the co-worker endorsement is accompanied by a narrative.

7. The method of claim 6, further including qualifying enhancement of co-worker endorsement by semantic analysis of the narrative's content.

8. The method of claim 6, further including assigning the talent-label points for self-nomination.

9. The method of claim 8, further including calculating the talent-label points according to a formula:
TLP=(a*SN)+(b*END1)+(c*END2)+(d*SEM), where
TLP is the talent-label points,
a, b, c and d are weights,
SN is a Boolean for self-nomination,
END1 is a count of co-worker endorsements accompanied by descriptions of the nominee's application of their talent,
END2 (optional) is a count of co-worker endorsements not accompanied by descriptions, and
SEM is a determination of talent application instances returned by semantic analysis of the intra-company fielded databases.

10. The method of claim 9, further including in the formula a factor+(c*END2), where END2 is a count of co-worker endorsements not accompanied by descriptions and c is a weight applied to END2.

11. The method of claim 1, wherein the work activity database is a fielded database.

12. The method of claim 1, further including responding to the queries by searching the talent-labels by keyword.

13. The method of claim 1, further including responding to the queries by searching the talent-labels using a taxonomy of talent-labels.

14. The method of claim 1, further including responding to follow-up queries for details on a particular nominee by including the particular nominee's talent-labels, talent-label points and a self-description of the particular nominee mashed up from a social network source.

15. A non-transitory computer readable storage including instructions that, when executed by a processor, cause the processor to:
receive a talent nomination that includes two or more talent-labels that identify a nominee's technical talents in a first category and a second category, wherein at least some of the talent-labels in the first category are more specific to the organization to which the nominee belongs than the talent-labels in the second category,
accumulate talent-label points for the nominee's talent-labels, including assigning talent-label points for at least co-worker endorsements and from analysis of at least one work activity database that describes work activity of the co-worker, and
respond to queries for particular technical talents by identifying one or more ii relevant talent-labels, one or more nominees for each relevant talent-label, and the identified nominees' talent-label points.

16. The computer readable storage of claim 15, wherein the first category lists intra-company task talents and the second category lists industry wide talents.

17. The computer readable storage of claim 15, further including talent-labels in the category of personal or recreational skills.

18. The computer readable storage of claim 15, further including causing the processor to create at least one of the talent-labels on demand while collecting a particular talent nomination.

19. The computer readable storage of claim 15, further including causing the processor to enhance the talent-label points for a co-worker endorsement when the co-worker endorsement is accompanied by a narrative.

20. A system for identifying particular technical talent within an organization, including:
a processor and memory coupled to the processor, the memory loaded with instructions that, when executed, cause the processor to:
receive a talent nomination that includes two or more talent-labels that identify a nominee's technical talents in a first category and a second category, wherein at least some of the talent-labels in the first category are more specific to the organization to which the nominee belongs than the talent-labels in the second category,
accumulate talent-label points for the nominee's talent-labels, including assigning talent-label points for at least co-worker endorsements and from analysis of at least one work activity database that describes work activity of the co-worker, and
respond to queries for particular technical talents by identifying one or more relevant talent-labels, one or more nominees for each relevant talent-label, and the identified nominees' talent-label points.

21. The computer readable storage of claim 20, wherein the first category lists intra-company task talents and the second category lists industry wide talents.

22. The computer readable storage of claim 20, further including talent-labels in the category of personal or recreational skills.

23. The computer readable storage of claim 20, further including causing the processor to create at least one of the talent-labels on demand while collecting a particular talent nomination.

24. The computer readable storage of claim 20, further including causing the processor to enhance the talent-label points for a co-worker endorsement when the co-worker endorsement is accompanied by a narrative.
